(19) United States
(12) Patent Application Publication
(10) Pub. No.: US 2016/0343016 A1
(43) Pub. Date: Nov. 24, 2016

(54) CUSTOMER REWARD SYSTEMS AND METHODS

(71) Applicant: Buzzub Inc., Saratoga, CA (US)

(72) Inventors: Sunil Pradeep Joshi, Saratoga, CA (US); Kalyan V. Krishnan, Fremont, CA (US)

(21) Appl. No.: 15/158,307

(22) Filed: May 18, 2016

Related U.S. Application Data
(60) Provisional application No. 62/163,824, filed on May 19, 2015.

(51) Int. Cl. G06Q 30/02

(52) U.S. Cl. CPC G06Q 30/0217

(57) ABSTRACT

Transaction parameters for a transaction between a customer and a merchant are provided to a reward service executing on a server system. The reward service assigns zero or more punches to the customer according to the transaction parameters based on legibility rules received from the merchant. The reward service further assigns a cash or points reward to the customer if punches assigned to the customer meet a threshold condition received by the reward service from the merchant. The reward may be assigned according to a tier of the customer, where the tier of the customer increases with a number of times the customer has met previously met the threshold condition. Punches may be provided to the customer as token including a token. The customer may then claim the token in order to associate the punch with the customer.

### RELATED APPLICATION

This application also claims the priority benefit of U.S. Provisional Application Ser. No. 62/163,824, entitled “PUNCH & TOKEN BASED LOYALTY REBATE REWARDS MECHANISMS”, filed May 19, 2015, the disclosure of which is incorporated by reference herein in its entirety.

### TECHNICAL FIELD

The present disclosure relates to systems and methods that implement, for example, customer reward programs offered by merchants offering goods or services for sale.

### BACKGROUND

Most conventional customer reward programs are integrated with point-of-sale (POS) devices, as implemented by large retailer chains and big box stores, for example. Small retail merchants, such as “mom and pop shops,” in general cannot avail of such customer reward program integration with their respective POS devices. Furthermore, a typical customer reward program as offered by, for example, credit card companies, often do not give a small retail merchant much flexibility with regards to customizing the customer reward program. Therefore, there exists a need for a customer reward program that can be implemented by a small retail merchant offering goods or services.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting a network environment in accordance with an embodiment of the present invention.

FIG. 2 is a block diagram illustrating data flow in accordance with an embodiment of the present invention.

FIG. 3 is a process flow diagram of a method for assigning rewards according to punches in accordance with an embodiment of the present invention.

FIG. 4 is a process flow diagram of a method for assigning punches to a transaction in accordance with an embodiment of the present invention.

FIG. 5 is process flow diagram of a method for determining an amount of a reward in accordance with an embodiment of the present invention.

FIGS. 6A through 6D are process flow diagrams of methods for assigning rewards using tokens in accordance with an embodiment of the present invention.

FIG. 7 is a block diagram that depicts a generalized processing architecture that can be used to implement the routing system and other systems and components discussed herein.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein describe a customer reward program. The rewards offered to a customer include, but are not limited to rewards such as cash back and points-based rewards. Some embodiments implement the customer reward program via methods that include application software running on one or more computing devices that include, but are not limited to laptop computers, desktop computers, mobile devices, tablet computers, or any combination of processing devices capable of connecting to a public network such as the Internet. Any combination of these computing devices may be in used by the customer or the merchant as a part of the customer reward program. In other embodiments, the implementation of the customer reward program is done independently of and without any interaction with the merchant point-of-sale device. Some embodiments of the systems and methods described herein use a cloud-based computing architecture that includes a server and a database, to implement at least a portion of the customer reward program architecture.

### TERMINOLOGY

Novel rewards mechanisms for consumers and merchants are described herein. In particular, new mechanisms are disclosed for providing rebates or cash-back that are tailored to suit differing business needs.

The following terms are used in this document:
Customers: Consumers who shop for goods and services from retail merchants.
Merchants: Retail stores/shops (with a physical store front or web-based businesses) where customers can buy goods/services.
Cloud/SaaS: Cloud-based Software-as-a-Service which can be accessed via a multitude of devices including Mobile devices such as smart phones and tablets, as well as desktop computers via web browsers. The systems and methods disclosed herein may be accessible via this approach in some embodiments.
Universal Cash Back (UCB): The cash-back that customers can receive on their purchases from participating merchants. This is the incentive and rewards program that may be administered according to the methods disclosed herein. The UCB is from the merchant to the customer, but may be routed via an intermediary implementing the systems and methods described herein, that provides value added services in return for a service charge to the merchant. Unlike the cash back rewards from banks/tender-companies (which happen when a purchase is made via a credit card), or from brand manufactures through rebate coupons, this cash-back is from a merchant to a customer, and is independent of whether the customer paid using a credit card or debit/ATM or cash or check. It is called Universal here because, in some embodiments, all Merchants participating in a rewards program as described herein universally use the same style of cash back.
Token: Tokens are physical or visibly displayed realization of a cash-back or rebate reward, where the amount of rebate is associated with a physical object or visible display including a special code. That money is then made available to the customer when that token is claimed by the customer.
Mobile Wallet: This is an account in the cloud that holds the UCB and other rewards, bonuses and gift card purchases. Each customer has a mobile wallet. Cash-backs and rebates are deposited to the mobile wallet, and if part of that money is used as payment for a purchase or withdrawn in some way, it is debited from the mobile wallet.
Merchant Appliance: This is an electronic device that a merchant uses that is dedicated to processing the UCB transactions for the customer. In some embodiments, it is a mobile smart phone provided by a reward service as described herein. The merchant appliance may be provisioned with a merchant application that converts the phone into a dedicated device that securely connects to a cloud-based server that performs processing of UCB transactions. It is also possible for the merchant to simply download the merchant application onto a supported mobile phone (or phablet) to convert the device into a merchant appliance. This application also discusses a way for the merchant to give out UCB Rewards using tokens, which does not require the use of the merchant appliance (however, redemption of the rewards may require it). The Merchant application may have many capabilities, one of which is to “claim” a token. The process of claiming is one whereby the code on the token is entered into a field in the merchant application, which is then communicated back to the reward service, which then registers it. This associates the token code with the merchant and in some cases with the value of the token that the merchant is giving as a reward using that Token.
Merchant Display (Tablet Display/Kiosk/TV; also referred to as Digital Signage): This is an optional electronic device at the merchant's location, which provides additional capabilities that complement those of the merchant appliance. It is typically placed at the counter or somewhere visible to consumers at the merchant location. The device may have WI-FI or wireless (3G/4G) capability. This digital signage can be a device that only displays advertisements of various sorts, including from other merchants in addition to this merchant, or it can also display transactional information that pertains to the customer that is being served or is interacting with it.
Merchant Application: This is a mobile application that runs on the merchant appliance and allows the merchant to administer and transact UCBs.
Customer Application: This is a mobile application that runs on a customer's smart phone that gives the customer the ability to administer his/her UCB account and also to find and interact with merchants. This application is optional for implementing the UCB program.
Reward Service: This is also referred to in the document as Cloud Service or just Service. This may be implemented as a SaaS service in the cloud that customers and merchants connect to and which holds the data and the logic for processing the transactions.

Prior Approaches

Some prior types of rewards include:
1. Discounts (e.g. 20% off the listed price; Clearance sale)
2. BOGOs (Buy One Get One x % off when purchased together)
3. Punch-Cards (e.g. buy a total of 10 burritos over a period of time and the 11^{th} is free)
4. Cash-Back Rewards (e.g. 2% cash back on restaurant bills)
5. Rebates (e.g. Mail-in rebates; Instant Rebates)
6. Reward Points (points can later be traded for goods/services/cash)
7. Travel Points (ditto)

It may be noted that items #1 and #2 fall in the category of “Discounts” or “Immediate Benefit” (IB), which means that what the shopper pays at the point of sale (POS) is reduced by the amount of discount given. However, items #3 to #7 are in the category of “Delayed Benefits” (DB), as the customer pays the full price for the item while purchasing, but is given a benefit that is redeemable later in the form of goods (e.g. 11^{th} burrito free), cash (e.g. cash-backs or rewards) or a convertible-benefit (e.g. reward points that can be traded for goods, or travel points that can be traded for goods or airline tickets).

While a customer may prefer instant discounts as it reduces what they pay, a merchant often prefers a delayed benefit approach as it helps build loyalty through repeat business as the customer has an incentive to continue shopping more.

It should also be noted that punch-cards (or punch-card apps on mobile devices, which effectively are the equivalent of paper punch-cards, but available and stored on apps on mobile phones) also provide an additional benefit to the merchant, namely “Delayed Cost” (DC), in contrast to other schemes that result in “Immediate Cost” (IC). In case of cash-back rewards, or rebates or reward or travel points, the merchant gives some kind of a reward to the customer at each purchase transaction. Especially, in the case of cash-back rewards (or rebates), the merchant is crediting the customer with a cash reward each time a transaction takes place, and this is an immediate cost to the merchant.

In contrast, when it comes to punch-cards, there is no immediate cost to the merchant. The way punch-cards (or mobile app versions of punch-cards referred to here as punch-apps) work is that when a customer purchases an item (usually of a relatively small value), then the merchant makes a notation on a small card (or on the app) in the form of a validation of purchase. This notation is most often in the form of a stamp, but is conventionally referred to as a punch. When a fixed number of punches or stamps are received, then the next purchase entitles the customer to a free item of an equivalent value. So, ten punches on burrito purchases results in the 11^{th} burrito being free. Often, in small businesses other similarly prices items (in our example, tacos and tostadas too) also qualify for a punch. It is only at the time of the last redemption (e.g. the 11^{th} free burrito) that there is a cost, which is referred to here as a delayed cost. Naturally, merchants prefer delaying their costs, resulting in the popularity of punch card systems for small and medium sized merchants.

Table 1 summarizes the existing reward types using the categories described above.

TABLE 1
Categorization of Existing Reward Programs

| | Goods/$/Points | Immediate | Delayed | Immediate | Delayed |
|---|---|---|---|---|---|
| | as Benefit to | Benefit to | Benefit to | Cost to | Cost to |
| Item/Category | Customer | Customer | Customer | Merchant | Merchant |
| Discounts | $ | Y | — | Y | — |
| BOGOs | $ | Y | — | Y | — |
| Punch-Cards | Goods | — | Y | — | Y |
| Cash-Backs & Rebates | $ | — | Y | Y | — |
| Reward/Travel Points | Points | — | Y | Y | Y (N if shared |
| | | | | | between merchants) |

Note that reward and travel points are usually given and committed when a purchase transaction is made. However, the actual cost to the merchant occurs only when the points get redeemed, and hence can be looked upon as a delayed cost. However, in many situations, points are shared between multiple merchants (e.g. travel mileage between airlines and hotels and car-rentals) and once earned are redeemable immediately, hence are considered more as an Immediate Cost, rather than Delayed Cost. It is only in the case when points are forfeited that there is no cost to the merchant.

It may also be noted above that the punch-cards do provide a delayed cost to the merchant, but the only prevalent practice in the marketplace for such merchants is that benefit to the customer is in the form of free offer of goods/services (e.g. free burrito, free coffee, free dinner, free car-wash etc.).

### SUMMARY OF DISCLOSED EMBODIMENTS

The embodiments disclosed herein provide an improved approach to providing rewards that apply to the other items in the delayed benefit category, but, just like punch-cards, they provide a delayed cost to the merchant. The first of these is referred to here as punch-cash. In this case, the benefit to the customer is in the form of cash, but unlike cash-backs or rebates, it is not provided immediately, but in a delayed fashion as described in detail below. The second is referred to here as punch-points, where the points are rewarded in a delayed fashion as explained in detail below.

Various mechanisms for awarding normal cash-back or rebates may be used, where the cash-back or rebate are a reward determined according to the approach described herein. For example, a reward may be provided to the customer according to the approaches described in U.S. application Serial No. [NETI-00100] filed [ ] and entitled CUSTOMER REWARD SYSTEMS AND METHODS and U.S. application Serial No. [NETI-00200] filed [ ] and entitled COMMUNICATION SYSTEMS AND METHODS, which are both hereby incorporated herein by reference for all purposes.

Examples of methods for providing rewards include i) using a merchant mobile phone application to give a reward to a customer by using the customer's mobile phone number as an identifier, and ii) providing a token (e.g. a physical object or temporarily displayed symbol or code) to the customer with a special code that can be claimed by the customer using the customer's mobile phone via text or using a customer app.

The reward types according to the embodiments disclosed herein may be characterized as shown in Table 2 (see punch-cash and punch-points entries).

TABLE 2
Categorization of Rewards Programs

| | Goods/$/Points | Immediate | Delayed | Immediate | Delayed |
|---|---|---|---|---|---|
| | as Benefit to | Benefit to | Benefit to | Cost to | Cost to |
| Item/Category | Customer | Customer | Customer | Merchant | Merchant |
| Discounts | $ | Y | — | Y | — |
| BOGOs | $ | Y | — | Y | — |
| Punch-Cards | Goods | — | Y | — | Y |
| Cash-Backs & Rebates | $ | — | Y | Y | — |
| Reward/Travel Points | Points | — | Y | Y | Y (N if shared |
| | | | | | between merchants) |
| Punch-Cash | $ | — | Y | — | Y |
| Punch-Points | Points | — | Y | — | Y |

The reward service may have several mechanisms for awarding normal cash-backs or rebates, which have been outlined and described in the above-referenced applications. These include i) using a merchant mobile phone application to give a reward to a customer by using the customer's mobile phone as an identifier, and ii) providing a token to the customer with a special code that can be claimed by the customer using his/her mobile phone via text or using a customer application. In both of these mechanisms, the dollar value of the cash is immediately deposited in the customer's mobile wallet 116 tied to the customer's mobile phone number. For example, the phone number may be the user identifier 118a for the mobile wallet 116 or may be mapped to the user identifier 118a of the customer. This mobile wallet 116 is also receive other rebates, rewards and gift card funds, making it a very versatile place to earn and accumulate reward money.

Punch-cash may be implemented using either of these mechanisms, but allows the reward itself to be defined as something that is contingent on multiple purchases, such that the reward actually is deposited into the mobile wallet 116 only after all the purchases are done. For example, assume a merchant offer that says “Buy 5 ice-creams and receive $2 Rebate.” The intent is that the five ice-cream purchases could be over a period of time and do not have to be all at once.

In this case, when the merchant gives the reward by scanning the customer's phone (or the customer claims a token code using his own phone), the reward service keeps track of how many times the reward has been given, and for the first four times, it does not transfer any reward cash, but on the fifth purchase, since the buy 5 ice-creams condition is met, it transfers the $2 rebate into the customer's mobile wallet. In other words, once the rules or conditions for the rebate have been provided to the service, the merchant only has to “punch” or validate the purchase, but not necessarily keep count or track it.

The reward service can keep track of the rules automatically and make the reward cash-back or rebate payment only when the condition is met. Essentially, during the first 4 punches, there was no cost to the merchant for the cash-back, and hence it is a delayed cost to merchant. If the customer were to only buy four times and never purchased the last time, there would be no obligation for the merchant to pay the reward. This essentially is the advantage of punch-cash over normal cash-back rebates, where had the cash-back been spread evenly (as $0.40 cash-back for each ice-cream purchase), it would have been an immediate cost and less pressure on the customer to be loyal and do repeat business.

For punch-points, the functionality may be identical to the punch-cash described above except that instead of cash-back or rebates given to the customer, at the end of the conditions being met, the customer is given reward points. Sometimes, points may be used in place of cash as they may come with fewer regulations or are simpler to transfer and redeem. Or they can just be a proxy for cash (for example, by saying 100 points equals $1) and can be converted later. Accordingly, punch-points are also an example of delayed cost (in terms of points) to the merchant.

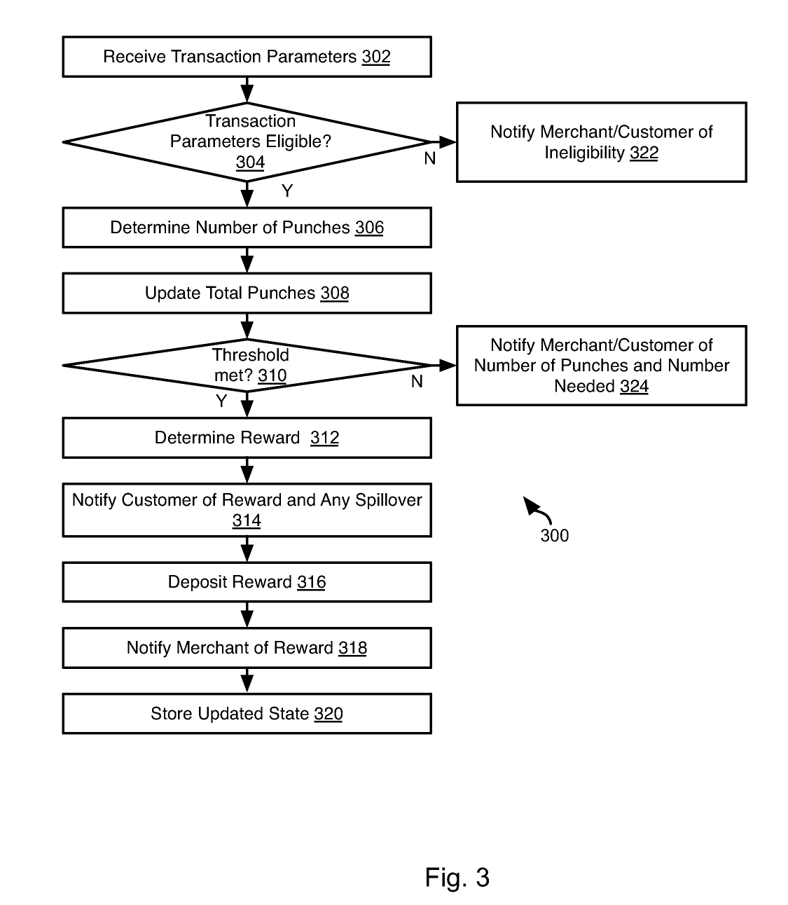

The methods by which punches and rewards are assigned are described in greater detail below with respect to FIGS. 3 through 5.

### Example Embodiments

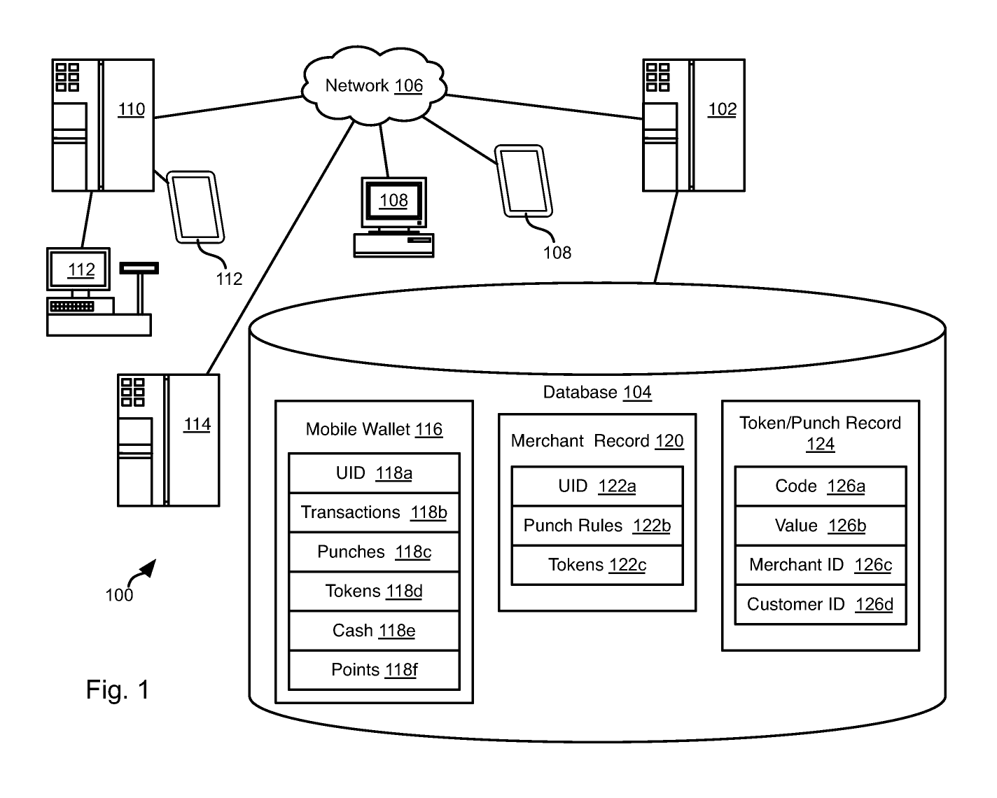

Referring to FIG. 1, the reward service may be implemented on a server system 102 within the illustrated network environment 100. The server system 102 may be a SaaS server system and may include a plurality of server computers. The server system 102 may host or access a database 104 storing data for use in accordance with the methods described herein. The server system 102 may be coupled to a network 106 such as a local area network (LAN), wide area network (WAN), the Internet, or any other type of wired or wireless network.

User computing devices 108 may interact with the server system 102 over the network 106. The user computing devices 108 may execute the customer application or may interact with the server system 102 using a general purpose communication method such as text message, email, telephone, or the like. The user computing devices may be embodied as a desktop or laptop computer, mobile phone, tablet computer, wearable computing device, or the like.

A merchant may interact with the server system 102 over the network 106. The merchant may operate a merchant server 110 and various merchant computing devices 112 may interact with the server system 102 by way of the server 110. Alternatively, merchant computing devices 112 may interact directly with the server system 106 over the network 106. The merchant computing devices 112 or server 110 may execute the merchant application or may interact with the server system 102 using a general purpose communication method such as text message, email, telephone, or the like. The merchant computing devices may be embodied as a point of sale (POS) device, desktop or laptop computer, mobile phone, tablet computer, wearable computing device, or the like.

In some embodiments, the server system 102 is also in data communication with a payment processing server 114. Electronic payments of rewards assigned according to the methods described herein may be processed by the payment processing server 114 in order to transfer funds from an account of a merchant to an account of a customer. In some embodiments, a merchant makes payments to the operator of the reward server system 102 such that payment of rewards are made by transferring funds from an account of the operator of the reward server system 102 and an account of the customer.

The database 104 may host various data structures that are used and modified according to the methods disclosed herein. For example, the database 104 may host a mobile wallet 116 for each customer of a plurality of customers. The mobile wallet 116 records data recording rewards assigned to the customer and used to determine rewards to assign to the customer. Each mobile wallet 116 may include a user identifier 118a, records of transactions 118b conducted by the customer with the merchant, punches 118c assigned to the customer according to the methods described herein, tokens 118d assigned to the customer according to the methods described herein, and cash rewards 118e assigned to the customer according to the methods disclosed herein. In some embodiments, rewards may be assigned in the form of points 118f that may be redeemed for products or cash. Accordingly, the mobile wallet 116 may record points assigned to the customer either in addition to or in place of the cash 118e.

The mobile wallet 116 may record data regarding one customer's interactions with one merchant. In some embodiments, the mobile wallet 116 may record data regarding one customer's interactions with a plurality of merchants that cooperate with respect to punches and rewards determined according to the methods described herein. In some embodiments, the mobile wallet 116 may also record data of multiple users in a family or otherwise collaborating for the collection of rewards according to the methods described herein.

A merchant record 120 may store data for a merchant or group of collaborating merchants. For purposes of this disclosure, unless expressly limited to a single merchant, references to a merchant shall be understood to apply to a group of collaborating merchants. For example, in situations where there is a chain store with multiple retail outlets under the same ownership or franchise situation, punches at different retail outlets could accumulate under the same store category. In other situations, different stores may create a partnership to allow punches to be accumulated under a common currency of punches, or even allow punches of one store to be allowed to be converted to punches of a different store with a conversion factor (e.g. two punches of Store A equal one punch of Store B).

A merchant record may include a user identifier 122a, or a set of group of identifiers for a plurality of merchants. The merchant record 120 may further store punch rules 122b that record criteria for assigning punches based on transactions of a customer and assigning rewards based on punches obtained. The punch rules 122b may, for example, implement the logic illustrated below with respect to FIGS. 3 through 5. A merchant record 120 may further store tokens 122c that have been claimed by the merchant according to the methods disclosed herein.

In some embodiments, tokens 118d in a mobile wallet 116 and in a merchant record 120 may reference a token record 124. A token record 124 may include a code 126a or identifier 126a that uniquely identifies the token represented by the token record 124. The code 126 may be the same as, or correspond exclusively to, a code or optical symbol printed on a physical object, such as printed on a paper, a plastic card, or temporarily displayed on digital signage.

A token record 124 may further include data values such as a value 126b that indicates a number of punches, amount of money, or number of points that have been assigned to the token according to the methods described herein. The token record may further include a merchant identifier 126c indicating the merchant that has claimed the token and a customer identifier 126d indicating the customer that has claimed the token. The merchant identifier 126c may correspond to the identifier 122a of a merchant record and the customer identifier 126d may correspond to the user identifier 118a of a customer record.

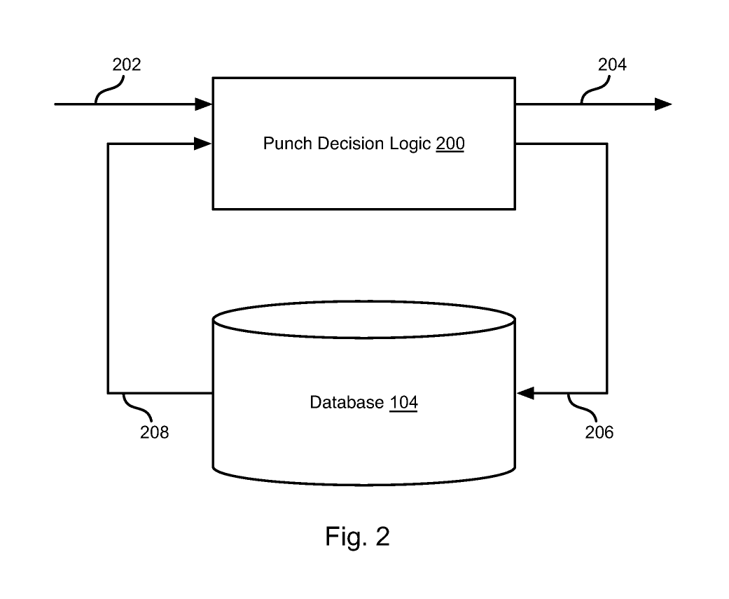

Referring to FIG. 2, the operation of punch-cash (or punch-points) may be represented as an input-output system with static information and intermediate results stored in the database 104. This decision logic 200 is designed to work in the cloud where the reward service is provided, such as using a server system 102. The decision logic 200 interacts with the merchant and customers at the retail store location via mobile devices 108, 112 and applications running on these devices. The merchant application or the consumer application transmits transaction parameters 202 to the decision logic 200. The decision logic may implement rules and constraints that are set up in advance by the merchant (or on behalf of the merchant) via an administrative portal for the merchant.

Outputs 204 are transmitted to the merchant's and customer's applications as appropriate. The outputs also result in intermediate data 206, which is stored back in persistent storage (e.g. the database 104) in the cloud. The stored data 208 is referenced on a per-customer basis each time a new transaction is initiated, since the output depends on both the stored state based on past results as well as the current transaction parameters. The systems and methods disclosed herein provide functionality that is significantly different than a conventional punch card systems

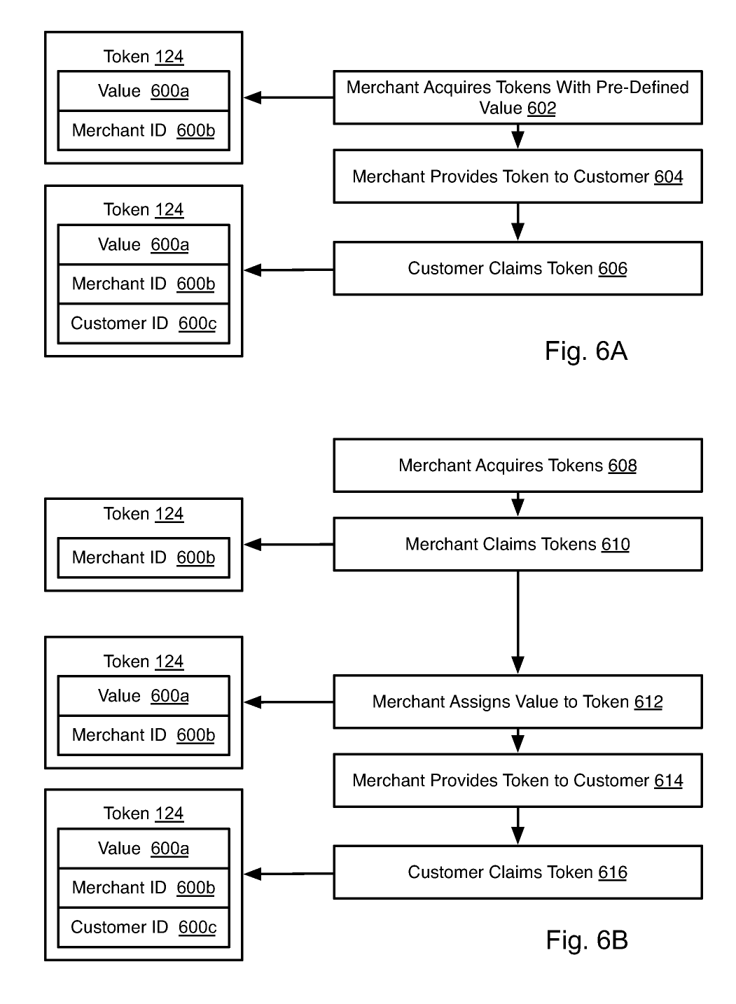

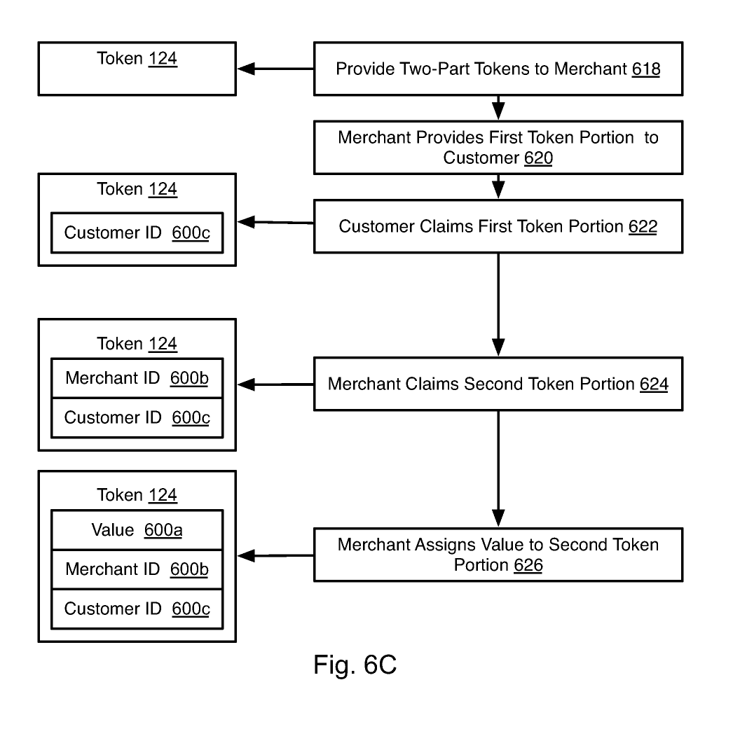

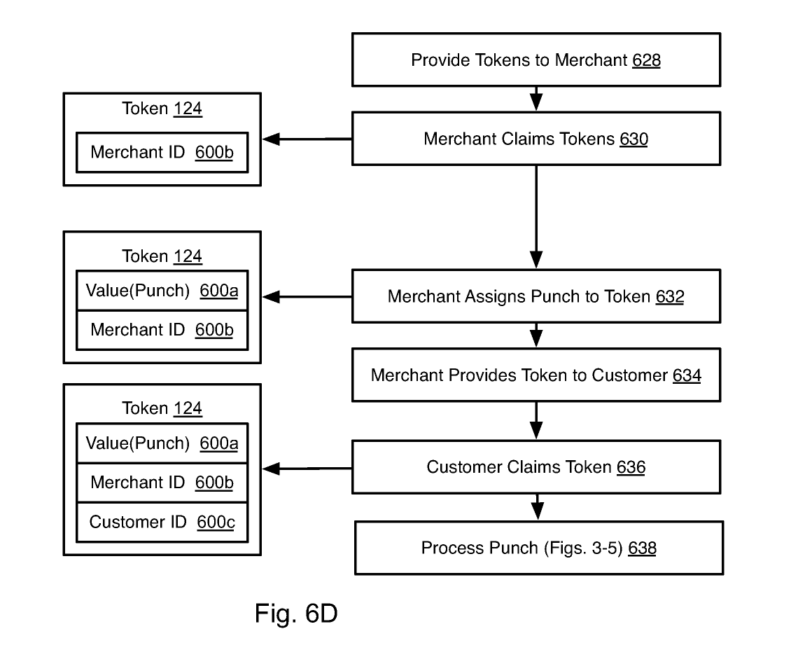

Referring to FIG. 3, the decision logic 200 executed by the server system 102 may execute the illustrated method 300 in response to transaction parameters 202 received 302 from a merchant or customer or in response to claiming of a token by a customer (see FIG. 6D). For example, the transaction parameters may be received from a client application executing on a customer computing device 108, merchant application executing on a merchant computing device 112, or from either of these devices independent of any application specific to interaction with the server system 102. For example, transaction parameters may be reported by text message, email, or other general-purpose communication method.

The transaction parameters 202 may include a record of purchase transactions of the customer while shopping at the merchant and include (other transactions that a customer can do, such as withdrawing funds from his/her account are not included here as they are decoupled from the point-of-sale transaction):
1. Customer ID (e.g. Mobile Phone number).
2. Type of items purchased (so that those that are covered by punch-cash/punch-points can be distinguished from those that are not).
3. Purchase Transaction Amount (as transactions may be bucketed to yield differing amounts of punches).
4. Action Taken: This can be i) a purchase, ii) a purchase that results in an automatic redemptions, iii) publicity actions (Facebook posts, Twitter tweets, blogs, Yelp reviews etc.), iv) a return of an item with a previous punch, or v) a partial redemption.

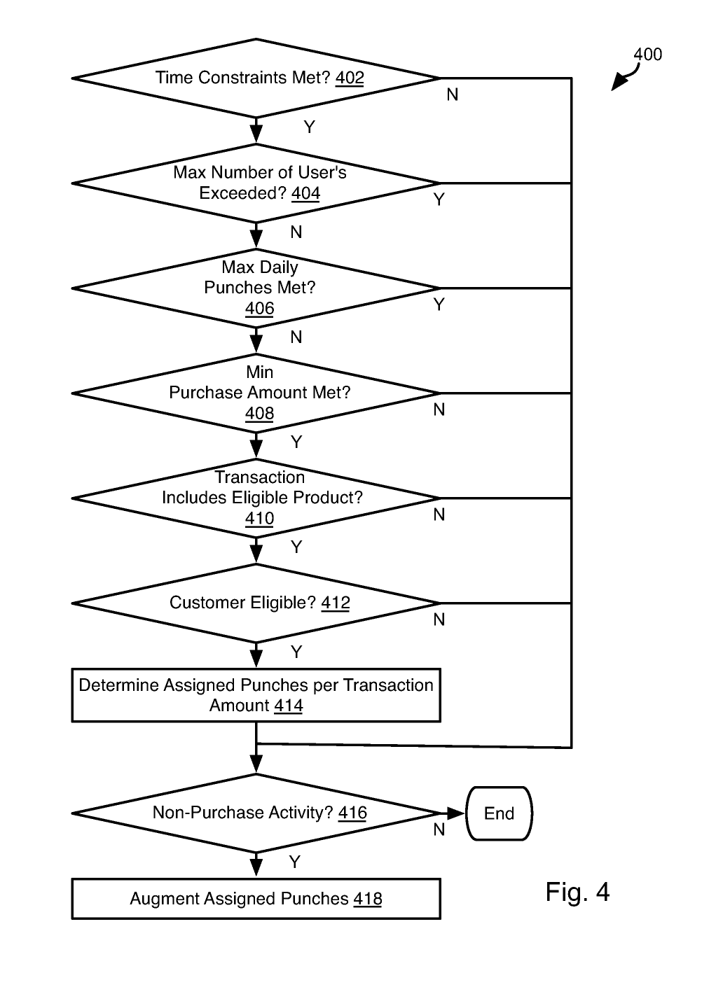

The method 300 may include evaluating 304 whether the transaction parameters 202 make the customer's purchase eligible to be considered. Evaluating 304 the eligibility of the transaction may include executing the method 400 of FIG. 4 described below.

If the transaction parameters 202 are found to be eligible, the method 300 may include determining 306 a number of punches to assign to the customer based on the transaction parameters 202. For example, the number of punches may be determined according to a function of purchase amount, purchase types (e.g. type of product or service purchased), a multi-punch eligibility for a particular purchase type as specified by the merchant, and any other criteria specified by the merchant. For example, a merchant may allow multiple punches for one transaction if a more expensive item was purchased (so, one burrito may be one punch, but a full dinner with drinks could be two punches).

In some embodiments, the number of punches is augmented based on non-purchase actions. For example, the merchant may include qualification rules that allow non-purchase actions to receive punches. These may include simply visiting the store, tweeting on Twitter, Facebook posts, blogs, Yelp positive reviews and other such items that result in publicity for the merchant. The number of punches determined for the transaction parameters or other non-purchase actions is referred to herein as “Pcurrent.”

The total punches of the customer is then updated 308. For example, the punch count stored in the database 104 of the customer (e.g. the punches 118c) is referred to as “Pprevious,” where Pprevious is zero in the very beginning, and gets updated/incremented as punches are earned, but not yet rewarded. Updating 308 may include adding Pprevious to Pcurrent to compute the total punches to date to obtain “Ptotal.”

In some embodiments, a merchant may require that all punches used to collect a reward be assigned within a certain timeframe (e.g. two weeks) or before a certain date, or else they become invalid or expire and the process starts again. Accordingly, updating 308 may include adjusting Pprevious to remove expired punches prior to calculating Ptotal.

The method 300 may further include evaluating 310 whether Ptotal meets a threshold condition. In some embodiments, a reward is available if the total punches earned are greater than or equal to a certain count, referred to herein as “Preward”. Accordingly, step 310 may include comparing Ptotal and Preward. In some embodiments, if Ptotal is less than Preward, then Ptotal is saved as Pprevious for the next purchase and the threshold condition is determined 310 not to have been met. If Ptotal is equal to Preward, then Pprevious is set to zero and the threshold condition is determined 310 to have been met. If Ptotal is more than Preward, then Pprevious is set to (Ptotal-Preward) as this indicates the spillover or extra punches earned beyond what were required and the threshold condition is determined 310 to have been met.

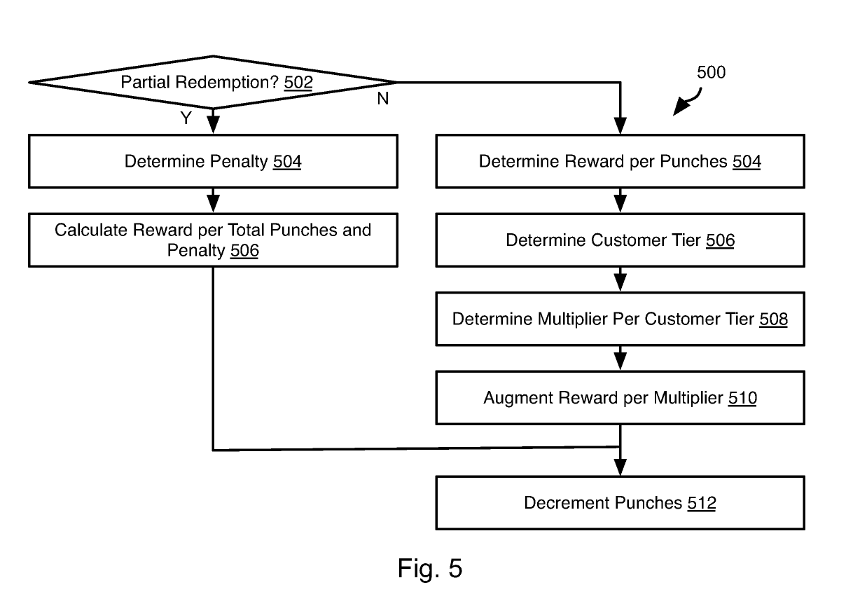

If the threshold condition is determined 310 to have been met, the method 300 may include determining 312 a reward amount. An example approach for determining the amount of a reward is described below with respect to FIG. 5. The customer may also be notified 314 of the reward. If a number of spillover punches is found, then the customer may be notified 314 of this spillover amount as well.

The reward may then be deposited 316. This may include depositing 316 the reward in the mobile wallet 116 of the customer, a bank account, a pre-paid credit card account, mailing a check, or any other payment method known in the art. Depositing 316 the reward may include transferring the reward from the operator of the reward service to the customer by means of the payment processing server 114. In some embodiments, depositing reward 316 may include transferring the reward from the merchant to the customer in the same manner as described above.

The merchant may likewise be notified 318 of the reward. In some embodiments, a stored state may be updated 320. This may include updating the mobile wallet 116 of the customer. In some embodiments, whenever a transaction takes place, a log or history is kept of all the key parameters of the transaction including the customer ID, time, date, purchase items, purchase amounts, and the previously stored values in the stored computation database. Also, the output result, including any additional punches earned are added to the currently stored count of punches, if the total is still below the threshold of punches required to reward in the form of cash-backs. If the threshold condition is met, then the spillover number of punches is stored in the mobile wallet 116.

If the transaction parameters are found to be ineligible, the customer and/or merchant may be notified 322 of this fact. The notification may indicate the reason the transaction was not found to be eligible. Likewise, if the number of punches of the customer after the updating step 308 is determined 310 not to meet the threshold condition, the customer and/or merchant may also be notified 324 of this fact.

The method 300 may be modified to accommodate various situations such as to provide for “un-punching” or removing punches. Conventional punch card systems do not have a way to achieve this, however, there can be situations where a customer may return some goods and a previously given punch may have to be undone. A merchant may optionally allow or disallow such an operation depending on the nature of the business. With punch-cash or punch-points, it is possible to take a punch (or multiple punches) out for specific situations of returns etc.

For example, if an item for which a punch (or punches) was earned is returned, then the punches counted earlier as Pcurrent should be treated as negative and the rest of the computations completed. However, if Ptotal becomes negative, then the return should be disallowed. Similarly, if the merchant allows and the customer wants to do a Partial Redemption, then too, a negative adjustment has to be made to the stored punch count, Pprevious, and the reward that is allowed for such a partial redemption can be given out.

As described below with respect to FIG. 6D, in some instances punches may be assigned using tokens, accordingly when a punch is claimed by a customer as described below, the method 300 may begin at step 306 with the determined number of punches being the number of punches assigned to the token claimed by the customer.

Referring to FIG. 4, the illustrated method 400 may be used to determine whether a transaction represented by a set of transaction parameters 202 is eligible to be assigned one or more punches. The method 400 may be executed by the server system 102 and may use logic and parameters provide by a merchant.

The method 400 may include evaluating 402 whether a time and data recorded in the transaction parameters fall within Dates, days and hours during which transactions are eligible to be awarded punches.

The method 400 may include evaluating 404 whether a maximum number of user's are exceeded. For example, a merchant may allow or disallow punches on one customer's card for items purchased by family members/friends. If the number of user's attempting to add transactions to the customer's account exceeds a limit set by the merchant, punches by users in excess of the limit may be prohibited.

The method 400 may include evaluating 406 whether a maximum daily (or weekly, monthly, or some other period) number of punches has already been met for the customer.

The method 400 may include evaluating 408 whether the transaction amount, e.g. total purchase price, of the transaction parameters 202 is greater than or equal to a minimum purchase amount.

The method 400 may include evaluating 410 whether one or more products listed in the transaction parameters 202 include at least one eligible product. For example, some kinds of purchases may be excluded from being eligible for punches, as per the merchant's choice on what items they are trying to promote.

The method 400 may include evaluating 412 whether a customer is eligible to receive punches and rewards from accumulating punches. For example, a merchant may have restrictions on which customers are eligible or not eligible for participation. These could be based on any factors such as their demographic, their zip-code, or whether they are employees of this business or not etc.

If the conditions of the evaluations 402-412 indicate that the transaction is eligible for punches, an amount of punches to assign is determined 414, such as described above with respect to step 306 of the method 300.

In some embodiments, the method 300 may include evaluating 416 whether there has been non-purchase activity reported in the transaction parameters 202 or otherwise reported to the server system in association with the customer. For example, the merchant may include qualification rules that allow non-purchase actions to receive punches. These may include simply visiting the store, tweeting on Twitter, Facebook posts, blogs, Yelp positive reviews and other such items that result in publicity for the merchant. Accordingly, if non-purchase activity is found 416 to meet the qualification rules, the number of punches is augmented 418. In some embodiments, non-purchase activity 416 may result in punches being assigned to the customer regardless of whether any of the conditions evaluated at steps 402-412 indicate ineligibility.

The amount of punches assigned to the user according to one or both of steps 414 and 418 may then be processed as described above with respect to step 308 of FIG. 3 and subsequent steps.

Referring to FIG. 5, the illustrated method 500 may be used to determine the amount of a reward. The method 500 may be executed by the server system 102 as part of step 312 of the method 300.

The method 500 may include determining 502 whether the customer is requesting a partial redemption. Is so, then a penalty is determined 504 and a reward is transferred to the customer according to the amount of punches accumulated by the customer. In a conventional punch card approach (buy 10 burritos and get the 11^{th} one free) there is no way to deal with partial redemptions, which means if the customer only has 5 punches, he cannot get half a free burrito. However, the server system 102 may implement redemption a partially completed set of punch-sets, if the merchant so chooses to allow. For example, suppose that acquiring 10 punches will result in a reward $10. Now, if a customer has accumulated 5 punches, and wants to close out the set early, the customer could at best hope for $5 as a proportionate reward. However, the merchant may not have an incentive to allow that, but may allow cashing out at a steep discount. So, for this example, a partial redemption may have a 50% penalty, and the customer may only get $2.50 (instead of $5). Such partial redemptions may also come with a service fees, or a minimum set of punch requirements at which partial redemption is permitted.

If no partial redemption is found 502 to be requested, the amount of the reward may be determined 504. This may include assigning a fixed reward: X dollars for Preward punches. In other embodiments, this may include assigning variable reward X=f(Ptotal, Preward), where f( ) is a function that increases with an amount by which Ptotal exceeds Preward.

The method 500 may further include determining 506 a tier of the customer. In some embodiments, a customer is assigned a tier by a merchant according to the number of times the customer has received a reward for achieving Preward punches. For example, the tier may be a function that increases with the number of previous rewards received by the customer.

The method 500 may then include determining 508 a multiplier according to the customer tier. For example, a customer who has acquired Preward punches N1 times may have a first multiplier M1 and a customer who has acquired Preward punches N2 times may have a multiplier M2, where N1 is greater than N2 if M2 is greater than M1.

The reward determined at step 504 may be augmented 510 according to the multiplier, such as by multiplying the reward by the multiplier or otherwise increasing the reward such that the amount of the reward increases with the number of times the customer has achieved Preward punches.

The punches of the customer may then be decremented 512 by the number of punches partially redeemed, by Preward if a fixed number of punches is used to determine the reward, or some other number of punches if the number of punches used to determine the reward is variable as described above. This may include setting Pprevious equal to Ptotal-Preward.

Where the assignment of a reward based on the customer's tier has been enabled by the merchant, then the database 104 may store a previous transaction history of the customer, including the number of previous transactions and punch-sets that were completed. Likewise, the merchant record 120 may include in the punch rules 122b one or more and the tiering rules and the corresponding rewards for each tier can be used to determine the actual reward amount. Accordingly, the stored transaction data may be used to determine 506 the customer's tier and augmented reward according to the tiering rules in the punch rules 122b for the merchant.

The use of tiers enables a merchant to measure ongoing purchases of customers that span multiple sets of punches and to enhance their associated rewards for extra loyal customers. For example, a completed, successful set of punches that result in a reward may be referred to as a “punch-set.” If 5 burrito punches have a reward of $3 on the 5^{th} punch, then if a customer has completed the 5 purchases and has received the $3 reward, this is referred to as one completed punch-set. Tiering is a way to recognize and reward further the loyal customers who not only complete one punch-set, but several, indicating their significant loyalty. Clearly, a customer that has completed ten punch-sets is quite loyal to the merchant, but one that has done 25 punch-sets is even more loyal. The tiering rule can automatically recognize punch-sets and enhance the reward at the end of each punch-set when it crosses a threshold or a tier. As an example, after ten punch-sets, the customer's reward could be 50% higher, which means that instead of $3 cash-back, the customer gets $4.5 cash-back on every punch-set beyond the tenth. There could be multiple tiers, so after crossing 25 punch-sets, the reward could be 100% higher, resulting in $6 per punch-set. Although described here with a percentage multiplier, this could also be set as absolute amounts of cash-backs (or points in case of punch-points).

FIGS. 6A to 6D illustrate an approach to assigning tokens to merchants and customers and assigning value to tokens, where the value is cash, points, a punch, or some other representation of something of value.

In the applications incorporated by reference above (“the incorporated applications”), various means are disclosed by which a reward system can process rebates, cash-back rewards as well as gift cards. In addition to the use of mobile apps for merchants and customers that can interact with the reward service and reward and credit the customer with an instant rebate or cash-back, the prior applications also described the use of paper tokens with an encrypted code on it that allows the token to be claimed by the customer to get the rebate or cash-back credited to the customer.

In the approach of these incorporated applications, a paper tokens (referred to here at tokens) have been described to work as follows:
1. The reward service prepares tokens with encrypted codes and via a process of activation, associates them with a merchant.
2. The tokens are also associated with a cash value, either at the time of creation or at the time of activation. The merchant can distinguish different Tokens of different values.
3. The merchant gives out the token of the right value to the customer based on the purchase transaction amount of the customer.
4. The customer subsequently “claims” the token. The claim process transfers the value of the reward on the token to the customer's mobile wallet 116. Claiming of a token can be done in one of many ways, including texting the code to a published service number or by using an app with a provision to claim the Token by entering the code.
5. The reward service, upon receiving the claiming of the token, can now associate the customer identifier with the token that already has the merchant and the value associated with it. The service can also derive to a reasonable extent (using some heuristics) the date and perhaps time when the Token may have been issued (which indicates the time of the purchase transaction).

The approaches of the incorporated applications is to enable data analytics on the customer transactions by capturing the following three (and if possible up to two more) parameters for each transaction: (1) customer ID, (2) merchant ID, (3) reward value (which is the value of the token), (4) the date and time of the transaction (optional), and (5) the purchase value of the transaction (optional).

The reward service preferably associates the first three items for any transaction in order to record it. The embodiments described below outline various mechanisms (in addition to the one described in the incorporated applications) may be used to achieve this association and various use cases are also disclosed.

The approach described below includes using tokens that each have a unique code. Associations may be added or bound to the token, including one or more of three items (a customer ID, a merchant ID and a value). These values may be bound to the unique code of the token by way of claiming process implemented by the reward service. This enables the reward service to make all the connections to create a full association specifying which customer got a reward of what value at what merchant. For example, when a customer claims the code from a mobile phone (via text or via an app), the service knows the customer ID of the customer and can connect that to the code. The service may already know that that specific code was already associated with a merchant and a value, in which case the association of all three is complete, or the service may get notified later, using an alternative mechanism (such as the merchant application) and can make the association at that point.

In some embodiments, when a reward is given, there is a value to that reward (for example, it can be a reward for $3). However, the value does not have to be a fixed number that is determined a priori. It can be a more complex mathematical function that results in a different number depending on other parameters or conditions. As a simple example, the value may have expired if the token is claimed beyond its expiration date, if any. Or the token may have been published with a variable value which declines gradually over time starting out at a high number and reducing with the passage of time. It can also be made a function of how many tokens have been cashed, if there is an incentive reward, which is limited to only the first fixed number of claimers. Another key example of a variable value token is with punch-cash (or punch-points), where, if there are multiple punches needed, then each token is equivalent to one punch, but the punch does not realize any value until the minimum number of punches to qualify for the reward are met. In other words, what is referred to as value here is really a variable value.

This concept may be understood more fully with respect to FIGS. 6A to 6D. Referring to FIG. 6A. A merchant may acquire 602 one or more tokens with a pre-defined value, which may be a variable value according to a function (e.g. expiration or decline with time). The tokens may be acquired 602 by the merchant purchasing the tokens in the form of physical objects from the reward service. The tokens may be pieces of paper, plastic cards, or any other physical object. The physical object may bear a unique code that defines the token or some other symbol that may be decoded or otherwise mapped to the unique code of a token. Specifically, each token may reference a token record 124.

In some embodiments, the tokens are acquired as a data file recording codes that each correspond to a token record 124. The tokens may then be provided to the customer by transmitting the code to a customer computing device 108 or temporarily displaying an optical symbol encoding the code or otherwise referencing the code on a display device, such as a bar code quick response (QR) code, numerals, or other visible image. The customer may then capture the code using the camera of a mobile phone and claim the token according to the methods disclosed herein and in the incorporated applications.

Upon acquiring 602 the tokens, the server system 102 may update the corresponding token records 124 to record the merchant identifier 600b of the merchant that has acquired them. In this example, the token records 124 already have a value 600a associated with them. Accordingly, after the acquiring step the token records 124 include a value 600a and a merchant identifier.

The method further includes providing 604 the token to the customer. This may include providing a physical object referencing the token record 124 or displaying an optical symbol referencing the token record 124. The customer may then claim 606 the token. As described in the incorporated applications, this may include the customer inputting to a customer computing device 108 the code or other value born by a physical object or temporarily displayed to the customer. The customer computing device 108 then transmits a claiming message including the code or other value to the server system 102, either as a text message, email, or other general purpose message or within the customer application.

Upon receiving the claiming message, the server system 102 associates the customer identifier 600c of the customer with the token 124. Specifically, the claiming message may include the customer identifier or the customer identifier may be obtained from data in the claiming message, e.g. the customer identifier may be the customer's phone number or email that was used to transmit the claiming message.

The token 124 is now associated with a value 600a, merchant identifier 600b, and customer identifier 600c, as shown in FIG. 6A.

FIG. 6B illustrates a use case that is particularly useful in sit-down restaurants, where the waiter brings the bill to the table. Since, each bill can be of different values, the merchant may not get pre-value-assigned tokens from the reward service. Instead, the merchant acquires 608 a quantity of tokens having unique codes (either the codes in a data file or as carries on physical objects, as described above) but no association of a value exists when the token is acquired 608. In some embodiments, the merchant identifier 600b of the merchant may be associated with the token records 124 of the acquired 602 tokens at the time of acquisition, e.g. before or during shipping of the tokens. However, this may be omitted in some embodiments.

For example, the waiter may prepare the bill and then, based on a reward amount that is advertised for that purchase amount, associate a value to the token record 124 of one of the acquired tokens, by claiming 610 the token and assigning 612 value to the token using the merchant app which provides this functionality. This process transmits to the server system 102 the merchant identifier for the merchant, the unique identifier of the token, and the value that the merchant wishes to assign to the token. Following claiming 610 and assigning 612 value, the token record 124 will therefore have a value 600a, a merchant identifier 600b, but no customer identifier associated with it.

When the Customer receives the bill, the customer may be provided 614 the token as the reward to for that dinner purchase. The customer may then claim 616 the token according to any of the methods disclosed herein or in the incorporated applications. Following claim 616, the token record 124 will then have all of a value 600a, merchant identifier 600b, and a customer identifier 600c associated with it.

An advantage of the approach of FIG. 6B is that the waiter does not have to bring a merchant computing device 112 executing a merchant application to the table in order to scan the customer's computing device 108 or otherwise communicate with a customer application executing on the customer's computing device 108, which can take time. Instead, the waiter need only hand the token to the customer along with the bill, thereby reducing overhead costs.

Of course, the example described above may be applied in any other context where a bill is provided and a token is given as a reward, i.e. any retail transaction.

In some embodiments, the sequence of steps of FIG. 6B is reversed such that an un-assigned Token is given to the customer, who then performs the claiming step 616. The customer then returns the token to the merchant (in the case of a physical token) and may provide a tip, in the example of a sit-down restaurant. The merchant can now calculate the reward value on the entire bill including the tip if desired. The claiming step 610 and value-assigning step 612 may then be performed as described above using this reward value.

Referring to FIG. 6C, in some embodiments the processing of a token may be done in parallel, rather than sequentially as for the preceding examples. This may be achieved by providing 618, to a merchant, a token that includes two portions that are duplicates with the same code. A first token portion is provided 620 to the customer and the second portion is retained by the merchant.

As shown in FIG. 6C, the customer may then claim 622 the token using the first portion in the manner described for the other embodiments herein, e.g. using a claiming message as described above. The token record 124 for the two-part token will therefore have the customer identifier 600c of the customer associated with it.

The merchant may then claim 624 the token using the second portion in the same manner described for the other embodiments herein. The merchant may also assign 626 a value to the token using the second portion in the same manner described hereinabove, i.e. a claiming message including the merchant identifier and a value. The token 124 will therefore now have a value 600a, merchant identifier 600b, and a customer identifier 600c associated with it.

The ordering of the steps may be reversed. For example, the claiming step 624 and value-assigning step 626 may be performed by the merchant before the claiming step 622 of the customer.

The advantage of splitting the token into two portions is that the Customer can leave with the first portion of the token copy and claim it when it is convenient and the Merchant can also keep a record of the token if needed, e.g. to claim the token and assign it a value when convenient.

Referring to FIG. 6D, the approaches for associating a merchant, customer, and value with a token may be incorporated into the use of punch-cash and punch-points as described above. In particular, rather than assigning a cash value, the token may be assigned value that is a punch that is processed in the manner described above (e.g. with respect to FIGS. 3 through 5).

In particular, the approach of punch-cash and punch-points, deals with accumulating credits such that the reward is given after an accumulation threshold is reached. For example, a restaurant may wish to incentivize its patrons to dine more often, so it has an offer that says it will give a $5 reward for every third dinner the customer purchases. This is a perfect case where punch-cash would work, as each dinner would get a punch, and the third dinner would be rewarded with $5 automatically.

The merchant using the merchant application could simply scan the customer's identity (via the customer's application) and put the reward amount in the customer's mobile wallet 116. The merchant application could have the offer listed as a punch-cash offer and the only operation the merchant would perform is the process of punching each time the customer dined.

However, in a situation where the merchant has some very busy periods, the merchant may be concerned about the overhead of having to scan the customer's identity to give the reward, as precious minutes could be lost with slow customers fumbling with their own phone applications, etc. In such a situation, the merchant may prefer to use tokens as described above with respect to FIGS. 6A to 6C, which pushes the burden of claiming a reward on to the customer. With the tokens, the merchant uses any one of the approaches described earlier to give a token to the customer, which the customer can claim at their own leisure. However, the token in this case does not necessarily have a fixed value associated with it. The token would have the equivalent of a single punch worth of value on it, and three Tokens would have to be claimed for the actual reward of $5 to be realized by the customer. So, in essence, this embodiment allows one to combine both the concept of punches with a delayed reward with the mechanism of tokens having the value of a punch, rather than a fixed dollar amount.

As shown in FIG. 6D, this approach may include providing 628 tokens to the merchant and the merchant claiming 630 the token in the same manner as for the embodiments of FIGS. 6A to 6C. However, the merchant assigns 632 a value to the token, where the value is a punch, rather than a cash value. The manner by which the value is assigned may be the same as for the approaches of FIGS. 6A to 6C, i.e. a claiming message specifying a number of punches and the merchant identifier. The merchant provides 634 the token to the customer and the customer claims 636 the token in the same manner described above. Accordingly, the token record 124 will have a value 600a that is one or more punches, a merchant identifier 600b, and a customer identifier 600c associated with it.

The punches assigned to the token record 124 may then be processed 638 in order to determine any reward to provide to the customer. Processing 638 may include, for example, executing some or all of the steps discussed above with respect to FIGS. 3 through 5.

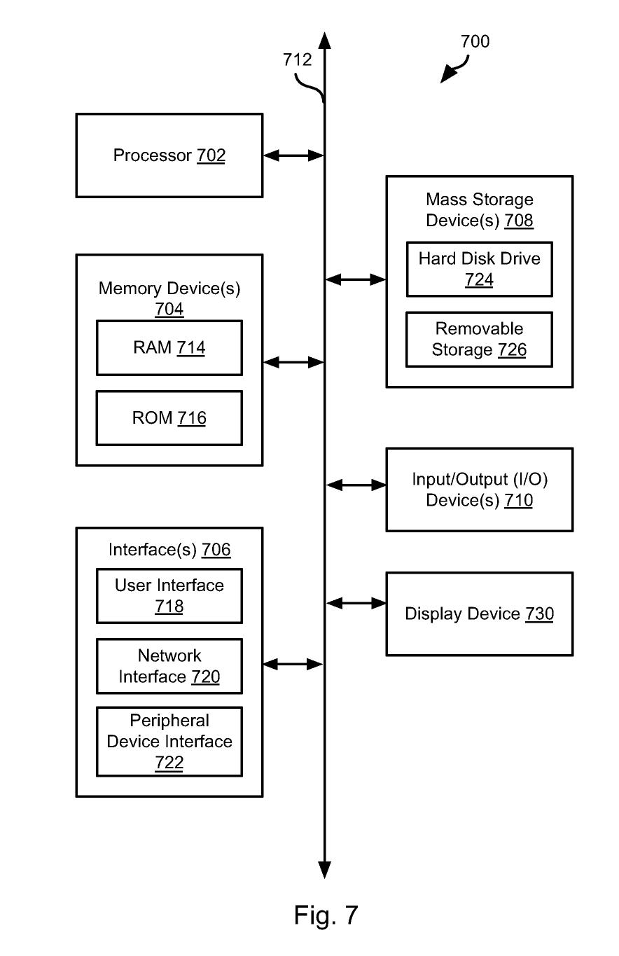

FIG. 7 is a block diagram illustrating an example computing device 700 which can be used to implement the systems and methods disclosed herein. The server system 102, database 104, user computing devices 108, merchant server 110, merchant computing devices 112, and payment processing server 114 may have some or all of the attributes of the computing device 700. Computing device 700 can function as a server, a client, or any other computing entity. Computing device 700 can perform various monitoring functions as discussed herein, and can execute one or more application programs, such as the application programs described herein. Computing device 700 can be any of a wide variety of computing devices, such as a desktop computer, a notebook computer, a server computer, a handheld computer, tablet computer and the like.

Computing device 700 includes one or more processor(s) 702, one or more memory device(s) 704, one or more interface(s) 706, one or more mass storage device(s) 708, one or more Input/Output (I/O) device(s) 710, and a display device 730 all of which are coupled to a bus 712. Processor(s) 702 include one or more processors or controllers that execute instructions stored in memory device(s) 704 and/or mass storage device(s) 708. Processor(s) 702 may also include various types of computer-readable media, such as cache memory.

Memory device(s) 704 include various computer-readable media, such as volatile memory (e.g., random access memory (RAM) 714) and/or nonvolatile memory (e.g., read-only memory (ROM) 716). Memory device(s) 704 may also include rewritable ROM, such as Flash memory.

Mass storage device(s) 708 include various computer readable media, such as magnetic tapes, magnetic disks, optical disks, solid-state memory (e.g., Flash memory), and so forth. As shown in FIG. 7, a particular mass storage device is a hard disk drive 724. Various drives may also be included in mass storage device(s) 708 to enable reading from and/or writing to the various computer readable media. Mass storage device(s) 708 include removable media 726 and/or non-removable media.

I/O device(s) 710 include various devices that allow data and/or other information to be input to or retrieved from computing device 700. Example I/O device(s) 710 include cursor control devices, keyboards, keypads, microphones, monitors or other display devices, speakers, printers, network interface cards, modems, lenses, CCDs or other image capture devices, and the like.

Display device 730 includes any type of device capable of displaying information to one or more users of computing device 700. Examples of display device 730 include a monitor, display terminal, video projection device, and the like.

Interface(s) 706 include various interfaces that allow computing device 700 to interact with other systems, devices, or computing environments. Example interface(s) 706 include any number of different network interfaces 720, such as interfaces to local area networks (LANs), wide area networks (WANs), wireless networks, and the Internet. Other interface(s) include user interface 718 and peripheral device interface 722. The interface(s) 706 may also include one or more user interface elements 718. The interface(s) 706 may also include one or more peripheral interfaces such as interfaces for printers, pointing devices (mice, track pad, etc.), keyboards, and the like.

Bus 712 allows processor(s) 702, memory device(s) 704, interface(s) 706, mass storage device(s) 708, and I/O device(s) 710 to communicate with one another, as well as other devices or components coupled to bus 712. Bus 712 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 700, and are executed by processor(s) 702. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although some of the embodiments described above discuss merchants with brick-and-mortar establishments, the systems and methods described herein can be extended to function with merchant e-commerce web sites. Methods of including the customer reward program as a part of a merchant e-commerce web site may include loose integration methods, where a customer completes an online purchase transaction on the website of a merchant participating in the customer reward program, and then separately claims their rewards on a separate web site that is associated with the customer reward program by using their purchase receipt, their customer ID and the ID of the merchant participating the customer reward program. Other embodiments that implement the customer reward program to function with merchant e-commerce websites may include tight integration methods, where the reward process is a part of the checkout operation on the website of the merchant participating in the customer reward program. A customer with a valid account with the customer reward program may use the customer reward program during the purchase transaction by signing in to the associated account during the checkout process.

Online merchants, such as those on sites like EBAY and ETSY, can also have a list of token codes given to them that they can send out to their purchasing customers. These can be in a physical form (e.g. paper token) along with the goods shipped, or in electronic form, such as in email for digital transactions. Upon receiving the token, the customer may then claim the token code in the same manner as described hereinabove to receive either a reward or a punch according to the value assigned to the token by the merchant according to the methods described herein.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method comprising:
receiving, by a server system, reports of a plurality of transactions of a customer from one or more remote computer systems;
for each transaction of at least a portion of the plurality of transactions incrementing, by the server system, a punch count of a customer;
determining, by the server system, that the punch count meets a threshold condition; and
in response to determining that the punch count meets the threshold condition, transferring, by the server system, a reward to the customer, the reward being at least one of cash and points.

2. The method of claim 1, wherein:
receiving the reports of the plurality of transactions of the customer comprises receiving the reports of the plurality of transactions of the customer from one or more merchant computing devices operated by a merchant;
the method further comprises receiving, by the server system, the threshold condition from the merchant.

3. The method of claim 2, further comprising receiving, by the server system punch criteria from the merchant;
wherein incrementing the punch count of the customer for the at least the portion of the plurality of transactions comprises:
determining that the at least the portion of the plurality of transactions satisfy the punch criteria; and
incrementing the punch count of the customer for the at least the portion of the plurality of transactions in response to determining that the at least the portion of the plurality of transactions satisfy the punch criteria.

4. The method of claim 3, wherein:
the punch criteria include one or more eligible products; and
determining that the at least the portion of the plurality of transactions satisfy the punch criteria comprises determining that product identifiers included in the reports for the at least the portion of the plurality of transactions corresponds to the one or more eligible products.

5. The method of claim 3, wherein:
the punch criteria include a minimum purchase amount; and
determining that the at least the portion of the plurality of transactions satisfy the punch criteria comprises determining that the at least the portion of the plurality of transactions have a purchase amount meeting the minimum purchase amount.

6. The method of claim 3, wherein:
the punch criteria include time and date limit; and
determining that the at least the portion of the plurality of transactions satisfy the punch criteria comprises determining that times and dates of the at least the portion of the plurality of transactions fall within the time and date limit.

7. The method of claim 3, wherein:
the punch criteria include a customer eligibility criteria; and
determining that the at least the portion of the plurality of transactions satisfy the punch criteria comprises determining that the customer meets the customer eligibility criteria.

8. The method of claim 1, wherein transferring the reward to the customer comprises transferring a cash reward to the customer.

9. The method of claim 1, further comprising calculating the reward by:
determining, by the server system, a base amount according to the punch count;
determining, by the server system, a tier of the customer such that the tier of the customer increases with a number of earned prior rewards according to prior meeting of the threshold condition by the punch count; and
calculating the reward as the base amount multiplied by a multiplier that increases with the tier of the customer.

10. The method of claim 1, further comprising:
determining, by the server system, a spillover amount that corresponds to an amount by which the punch count exceeds the threshold condition; and
setting, by the server system, the punch count equal to the spillover amount.

11. A method comprising:
providing, by a server system, a plurality of token codes to a merchant;
for each token code of the plurality of token codes—
receiving, by the server system, a merchant claiming message from a merchant computer, the claiming message including the each token code and a merchant identifier;
storing, by the server system, the merchant identifier in a token record corresponding to the each token code in a token database;
receiving, by the server system, a value message from the merchant, the value message including the each token code and a value to be assigned to the each token code;
storing, by the server system, the value in the token record;
receiving, by the server system, a customer claiming message from a customer computer of a customer, the customer claiming message including the each token code and a customer identifier; and
storing, by the server system, the customer identifier in the token record;
wherein the merchant claiming message and customer claiming message are temporally offset from one another;

12. The method of claim 11, wherein the merchant claiming message precedes the customer claiming message.

13. The method of claim 11, wherein the merchant claiming message follows the customer claiming message.

14. The method of claim 13, wherein the value message follows the customer claiming message.

15. The method of claim 11, wherein providing the plurality of token codes to the merchant comprises providing a plurality of physical objects, each physical object having an encoding of one of the token codes of the plurality of token codes affixed thereto.

16. The method of claim 11, further comprising:
providing, by the merchant computer, the each token code to the customer by displaying an encoding of the each token code on a computer screen;
capturing, by the customer computer, the encoding of the each token code using an optical device; and
transmitting, by the customer computer, the customer claiming message in response to capturing the encoding of the each token code.

17. The method of claim 11, wherein providing the plurality of token codes to the merchant comprises providing a plurality of physical objects, each physical object having a first portion and a second portion, both of the first portion and second portion having a same token code of the plurality of token codes affixed thereto.

18. The method of claim 1, further comprising, in response to receiving the customer claiming message:
incrementing, by the server system, a punch count of the customer in the database;
determining, by the server system, that the punch count meets a threshold condition; and
in response to determining that the punch count meets the threshold condition, transferring, by the server system, a reward to the customer, the reward being at least one of cash and points.

19. The method of claim 18, wherein the value in the value message includes a number of punches, wherein incrementing the punch count of the customer includes incrementing the punch count by the number of punches.

20. The method of claim 18, wherein the reward is cash.
